(19) United States
(12) Patent Application Publication
(10) Pub. No.: US 2023/0111720 A1
(43) Pub. Date: Apr. 13, 2023

(54) BARBECUE GRILL AND CART FOLDING ASSEMBLY

(71) Applicant: Hailong Wang, Barrie (CA)

(72) Inventor: Hailong Wang, Barrie (CA)

(21) Appl. No.: 17/499,799

(22) Filed: Oct. 12, 2021

(51) Int. Cl. A47J 37/07; F24C 15/08

(52) U.S. Cl. CPC A47J 37/0786; A47J 37/0704; F24C 15/08; A47J 2037/0777

(57) ABSTRACT

The presented invention related to grill and cart folding assembly. Grill is able to rotate around a pivot on a cart, grill can be rotated to upright position for use, and the grill can also be rotated to folding position in the cart for transportation. The grill will be secured to the cart by swing arm or support bar when the grill rotates to upright position for use. The other option of securing the grill to the cart is by shoulder screws and nuts when the grill rotates to upright position for use.

### FIELD OF THE INVENTION

The present invention related to barbecue grill and cart folding assembly. The cart securely supports grill and the grill can be rotated to upright position for use and can also be rotated into cart for transportation or storage.

### BACKGROUND OF THE INVENTION

Grilling is very popular in North America. There are some inventions for portable grill folding cart (U.S. Pat. 9,187,108B2, Adrian Bruno et al). But for heavy duty and large BTU grills there is no better method to handle the quick assembly and transportation. Users have to spend a lot of time to assemble grill and cart when they purchase the grill or when they want to transport the grill from one location to other location. There is a need for a cart that can be used to securely support grill during use and can also easily fold the grill into cart for transportation and for storage.

Accordingly, it is an object of the present invention to provide grill and cart assembly that grill can be rotated into cart for transportation and also can be raised up and secured in upright position for use.

Another object of the present invention is to provide a grill cart with lock mechanisms that securely lock the grill to the cart for use and for transportation.

Yet another object of the present invention is to provide pivot axis for the grill to rotate around the axis. The grill can be rotated to upright position for use or rotated to folding position for transportation.

Yet a further object of the present invention is to provide a screw locked swing arm to support and lock the grill securely in upright position for use.

Yet a further object of the present invention is to provide a supporting bar to support and lock the grill securely in upright position for use.

Yet a further object of the present invention is to provide screw locked pins to lock the grill securely in upright position for use.

### SUMMARY OF THE INVENTION

The present inventions preserve the advantages of known cart that can be used with grills or smokers, including gas grills, charcoal grills, wood grills and pellet grills or smokers.

More particularly, the present inventions provide a cart for grill, the cart having a pivot axis; grill can rotate on the axis. The axis may be pivot pins type or pivot hinges type. For the pivot pin type mechanism, one side of the pivot pin is secured to the cart frame by shoulder screws or by other means, there are bushings and nuts secured on the grill, the shoulder screw inserts into the bushing on the grill and secured into the nut, the grill can be rotated on the cart. The grill will be secured to the cart by screw pins or swing arms when grill rotates to upright position for use. For the hinge type mechanism, one side of the hinge is secured to the cart and other side of the hinge is secured to the grill, the grill can rotate around the hinges on the cart. The grill will be secured to the cart by swing arm or screw pins or by supporting bar when grill rotates to upright position for use. The grill can also be rotated to folding position in the cart for transportation. The grill will stay in folding position by gravity; the grill can also be secured by screws when the grill is at folding position.

The present inventions further provide a cart with 2 or 4 wheels or castors for transportation.

The present inventions further provide side shelfs for barbecue tools and food storage.

### BRIEF DESCRIPTION OF THE DRAWINGS

The stated and unstated objects, features and advantages of the present inventions will become apparent from the following descriptions and drawings, and in which:

FIG. 1 is a perspective view of cart and grill assembly with side shelfs of the present invention in an upright and locked position for use.

FIG. 2 is a perspective view of cart and grill assembly without side shelfs of the present invention in an upright and locked position for use. This fig shows the swing arm option of securing the grill to the cart.

FIG. 2A is a detail perspective view of the swing arm securing grill and cart of the present invention in an upright and locked position for use.

FIG. 2B is a side view of cart and grill assembly of the present invention in an upright position, the swing arm is rotated down to the open position for the grill to rotate down into the cart.

FIG. 2C is a side view of cart and grill assembly of the present invention with the grill in folding position, the grill is rotated down into the cart.

FIG. 2D is a side view of cart and grill assembly of the present invention in a folding position, the swing arm is rotated up to the close position and the swing arm is secured to the cart by two screws. grill is secured to the cart by two screws.

FIG. 2E is a perspective view of cart and grill assembly of the present invention with the grill in a folding position.

FIG. 2F is a perspective view of cart and grill assembly of the present invention in a folding position for packaging and transportation. This position is preferred for transportation, the grill will keep the position by its gravity.

FIG. 3 is a perspective view of cart and grill assembly without side shelfs of the present invention in an upright position. This fig shows an option of using supporting bar to secure grill to cart.

FIG. 3A is a detail perspective view of the supporting bar to secure grill to the cart of the present invention in an upright and locked position for use. The fig shows left side of the supporting bar is secured on the cart by shoulder screw, and the right side of the bar is secured to grill and cart by 2 screws; the other option of using this supporting bar is to securing the bar to grill and cart by using 2 screws on each side (left side is same as right side of the bar on the FIG. 3A).

FIG. 4 is a perspective view of cart and grill assembly without side shelfs of the present invention in an upright position. This fig shows another option of securing grill to cart by using 2 shoulder screws.

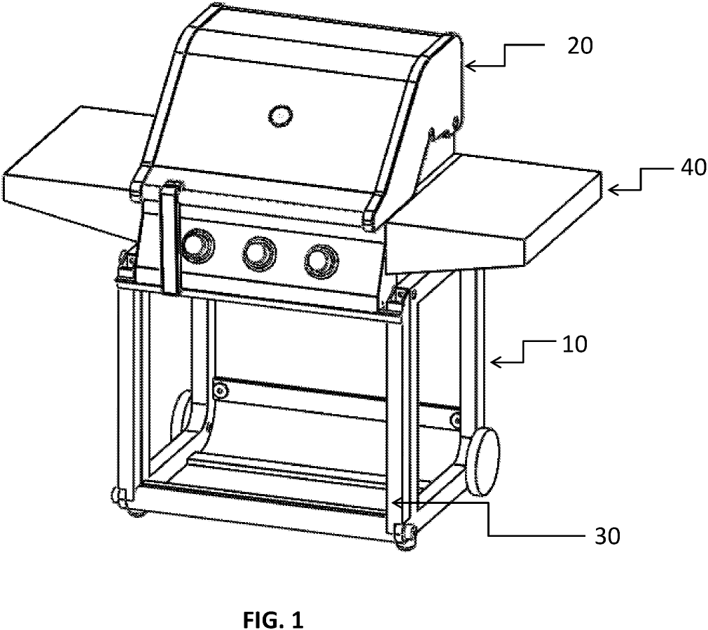

### DETAILED DESCRIPTION OF PREFERRED EMBODIMENTS

Below is the description of what is currently believed to be preferred embodiments or the best representative examples of the claimed inventions. Future and present alternatives and modifications to the embodiments and preferred embodiments are contemplated. Any alternatives or modifications which make insubstantial changes in function, purpose, structure or result are intended to be covered by the claims of this patent.

The cart of the present invention is shown generally as 10 in the Figures. It supports the grill 20, the grill types, including gas grills, charcoal grills, wood grills and pellet grills or smokers. The grill 20 is secured to the cart 10 by the swing arm 30. The side shelf 40 can be mounted to the grill or on the cart. It will also be understood that the components of the present invention may be made out of a variety of materials, such as stainless steel, carbon steel, aluminum and/or plastics, consistent with the function of the components.

The assembly of a preferred cart 10 include a frame assembly 12, a pivot screw pin 17, transportation wheel 11, feet 15, and cushion bumper 16. As used herein for reference and describe the relationship of various components, right and left side are referenced to the front side of the grill by facing to the grill 20. Similarly, front and rear are reference to the front and rear of the grill. The cart is mirror symmetry from left to right except the transportation wheels; the wheels may have 4 units of wheels or 2 units of wheels, or may have 2 straight wheels and 2 swinging wheels, or mar have 2 wheels and 2 feet. The straight wheels may setup in rolling direction of left/right or front/rear.

The assembly of a preferred grill 20 include grill lid 21, cook box 22, grill pivot nut 23, and grill lid lock 24. Here we show only grill components which related to the grill raising up or folding down functions. The grill is mirror symmetry from left to right except the lid lock 24.

The assembly of a preferred swing arm 30 include a swing arm assembly 31, shoulder screw 13, nut 14, secure screw 18,19. The swing arm is mirror symmetry from left to right.

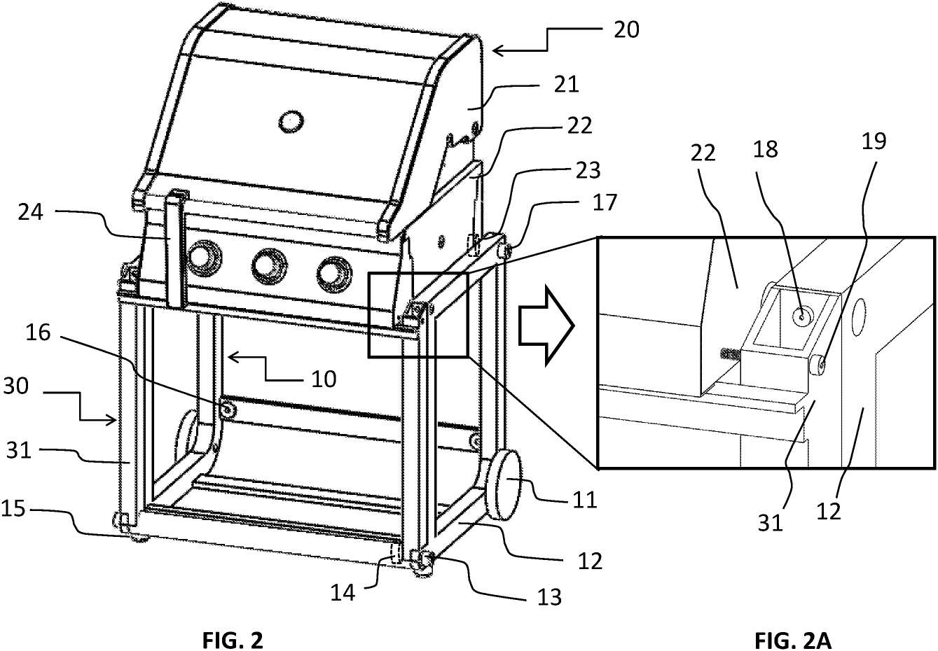

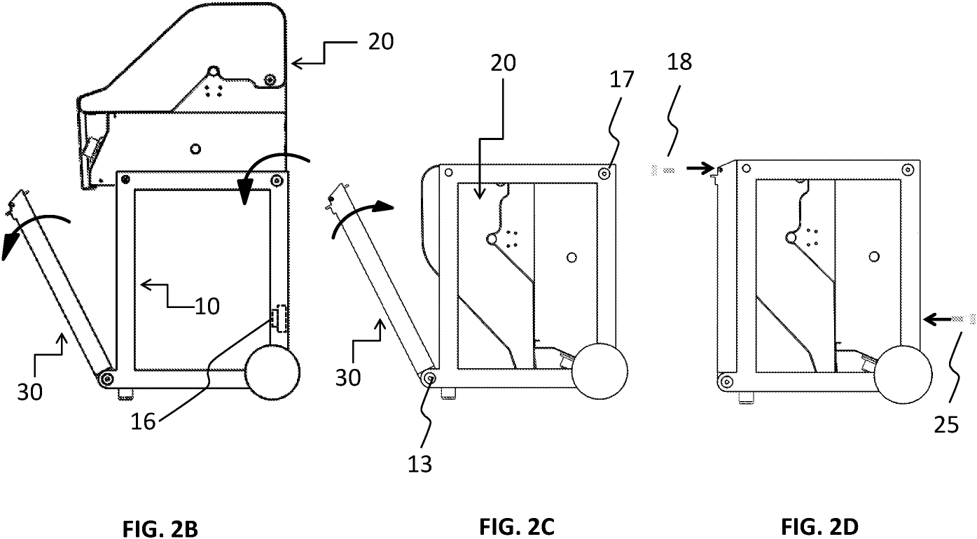

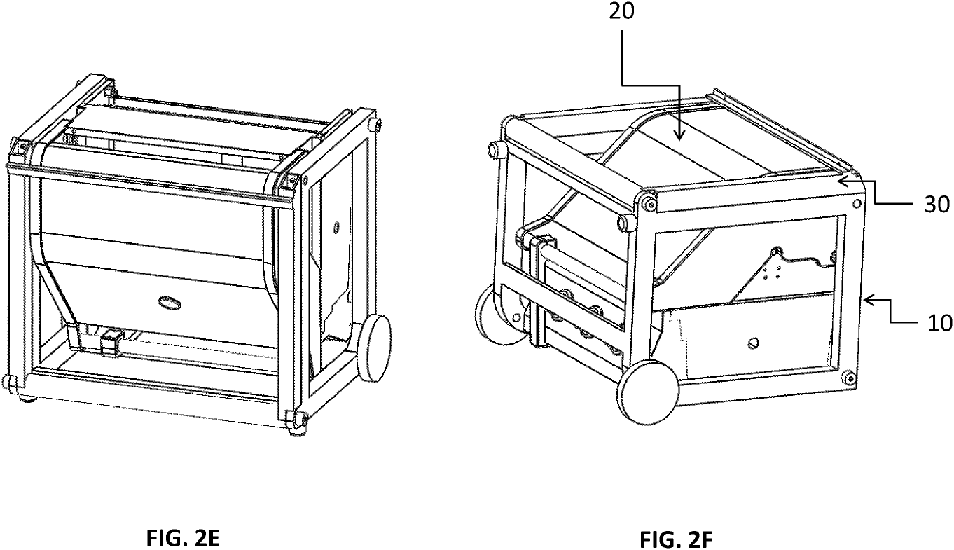

In preferred embodiment, when grill 20 is at upright position, the grill 20 is supported by swing arm 30 and secured to cart 10 by 2 screw 18, 19 on right side, and another 2 screw pins mirror symmetry on left side. (See FIG. 2A).

As shown in FIGS. 2B, 2C and 2D, the grill 20 can be folded into cart 10 for transportation. In preferred embodiment, unscrew the screw 18 and unscrew the screw 19 on the right side of the swing arm and unscrew the screws on the mirror symmetry on left side, swing the swing arm 30 to open position (see FIG. 2B), hold the grill 20 and let it slowly swing down into the cart 10. The grill 20 will be stopped by the cushion bumpers 16 on the cart frame 12 by gravity (see FIG. 2C). Further more secure the grill 20 at folding down position by screw 25, this will prevent grill swing during transportation. Swing the swing arm 30 to close position and secure the swing arm to the cart using screw 18 (see FIG. 2D).

In order to rotate grill from folding position to upright position for use, we need to reverse the steps in FIGS. 2B, 2C and 2D.

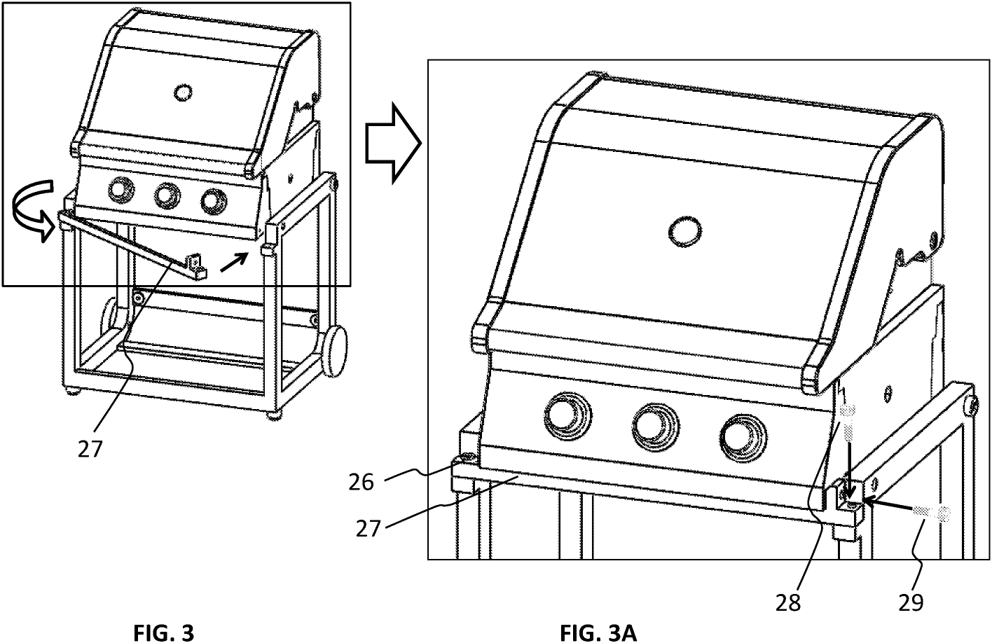

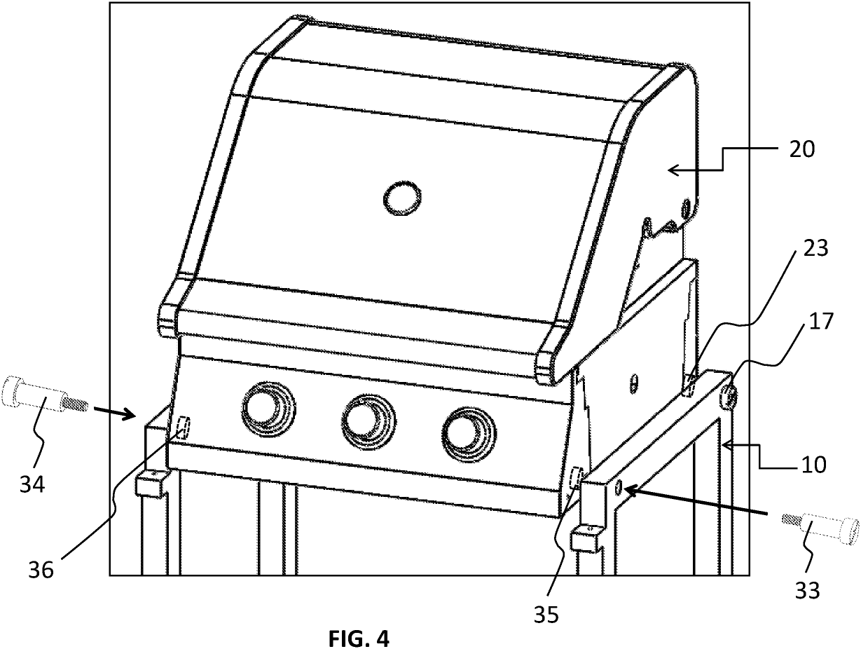

Another option of securing grill to cart is to use supporting bar 27 as shown in FIG. 3. This fig shows another way of securing grill to cart other than using swing arm 30.

FIG. 3A is a detail perspective view of how supporting bar 27 secures grill to the cart of the present invention in an upright position for use. The fig shows left side of the supporting bar 27 is secured on the cart by shoulder screw 26, and the right side of the bar is secured to grill and cart by 2 screws 28,29; the other option of using the supporting bar 27 is to securing the bar 27 to grill 20 and cart 10 by using 2 screws on each side of the bar 27 (same as right side of the bar on the FIG. 3A).

Yet another example of securing grill to cart is to use shoulder screws 33,34 as shown in FIG. 4. This fig shows the optional way of using shoulder screws to secure grill to cart. Hold the grill 20 and line the nuts 35, 36 on the grill with the hole on the cart, insert and secure the shoulder screws 33, 34 to the nuts 35,36 on the grill.

The above description is not intended to limit the meaning of the words used in the scope of the following claims that define the invention. Rather, it is contemplated that future modifications in structure, function or result will exist that are changes in what is claimed are intended to be covered by the claims. Thus, while preferred embodiments of the present inventions have been illustrated and described, it will be understood that changes and modifications can be made without departing from the claimed invention.

What is claimed is:

1. A grill and cart folding assembly, grill can rotate around a pivot on a cart, grill can be rotated to upright position and secured to the cart for use, grill can also be rotated to folding position in the cart for transportation.

2. The grill and cart folding assembly of claim 1 wherein said pivot include bushing and nut or hinge on the grill, and axis pin or hinge on cart.

3. The grill and cart folding assembly of claim 1 wherein said having swing arm to secure grill to the cart at upright position for use.

4. The grill and cart folding assembly of claim 1 wherein said having supporting bar to support the grill to the cart at upright position for use, the supporting bar is secured to the cart and grill by screws. This is the optional way of securing grill to cart.

5. The grill and cart folding assembly of claim 1 wherein said at least have 2 shoulder screws to securely support the grill to the cart at upright position for use. This is another optional way of securing grill to cart.

6. The grill and cart folding assembly of claim 1 wherein said having 2 screws to secure the grill to cart at folding position for transportation.

7. The grill and cart folding assembly of claim 1 wherein said having cushion bumpers on cart for the grill soft landing when grill folding down into cart by gravity.

8. The grill and cart folding assembly of claim 1 wherein said having wheels or castors for moving grill and cart.
